(19) United States
(12) Patent Application Publication
(10) Pub. No.: US 2006/0130691 A1
(43) Pub. Date: Jun. 22, 2006

(54) Photosensitive printing plate automatic feeding apparatus and method

(75) Inventors: Yoshinori Kawamura, Kanagawa (JP); Kikuo Matsuba, Kanagawa (JP); Kazuoki Komiyama, Kanagawa (JP); Toru Itakura, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/311,266

(22) Filed: Dec. 20, 2005

(30) Foreign Application Priority Data
Dec. 22, 2004 (JP) 2004-371784

(51) Int. Cl. B41F 27/12

(52) U.S. Cl. 101/477

(57) ABSTRACT

An apparatus automatically feeds photosensitive printing plates having the characteristic that transport and storage are possible in a state where the photosensitive printing plates have been stacked together such that back sides of the photosensitive printing plates are brought into direct contact with photosensitive surfaces on front sides of the photosensitive printing plates. The apparatus includes: a storage member that accommodates a bundle comprising a plural number of the photosensitive printing plates stacked together without slip sheets; a takeout member that separates and takes out the photosensitive printing plates from the bundle one plate at a time; and a conveyance member that conveys the taken-out photosensitive printing plates to an exposure apparatus. According to this apparatus, the conventional configuration and process of separating, conveying, and stocking slip sheets from the photosensitive surfaces of the photosensitive printing plates can be omitted.

### CROSS-REFERENCE TO RELATED APPLICATION

This application claims priority under 35 USC 119 from Japanese Patent Application No. 2004-371784, the disclosure of which is incorporated by reference herein.

### BACKGROUND OF THE INVENTION

1. Field of the Invention

The present invention relates to a photosensitive printing plate automatic feeding apparatus including a sheet feeding apparatus into which is loaded a bundle of just plural photosensitive printing plates and which separates and takes out the photosensitive printing plates one plate at a time, and a photosensitive printing plate automatic feeding method using the photosensitive printing plate automatic feeding apparatus.

2. Description of the Related Art

Photosensitive printing plates (PS plates) are commonly used in offset printing. And in the field of offset printing, computer-to-plate (CTP) systems have come into practical use. CTP systems manufacture direct printing plates by receiving an unexposed photosensitive printing plate fed thereto, laser-exposing the photosensitive printing plate on the basis of digital data from a computer or the like, and developing the photosensitive printing plate such that the latent image formed on the photosensitive printing plate is converted to an overt image by an automatic developer.

Some CTP systems are disposed with a photosensitive printing plate automatic feeding apparatus. The photosensitive printing plate automatic feeding apparatus includes a housing that is shielded from light and into which is loaded a bundle comprising a plural number of photosensitive printing plates and slip sheets alternately stacked together. When plate manufacture begins, a sheet feeding apparatus of the automatic feeding apparatus removes the slip sheets from the bundle of the photosensitive printing plates, separates the photosensitive printing plates one plate at a time, and conveys the photosensitive printing plates to an exposure unit.

The photosensitive printing plates used in such CTP systems are formed by applying a photosensitive layer on the surface of a thin aluminum plate, for example. Changes arise in the photosensitive layer even when the photosensitive layer is exposed to a slight amount of light. Such photosensitive printing plates also have the property that changes arise in the photosensitive layer when they absorb airborne moisture.

It is also common for conventional photosensitive printing plates to be relatively easily susceptible to so-called pressure marks, which cause changes in the photosensitive layer when pressure is applied to the photosensitive layer, and scratches resulting from external force.

Thus, in order to prevent changes in product quality, such as pressure marks and scratches, from arising in the photosensitive printing plates from the time when the photosensitive printing plates are manufactured in a factory to until the photosensitive printing plates are loaded into the automatic feeding apparatus of the CTP system through the course of distribution in which the photosensitive printing plates are transported and stored, sheets of protective paper (slip sheets) are disposed on the photosensitive surfaces of the photosensitive printing plates. The photosensitive printing plates are then bundled into a predetermined number of plates, thick sheets of paper (contact board made of corrugated cardboard) are disposed on the front side and the back side of the bundle, and these are fixed with fixing means such as adhesive tape to prevent slippage, such that the photosensitive printing plates and the slip sheets are integrally bundled together and maintains the bundled shape thereof. The bundle of the predetermined plural number of photosensitive printing plates integrally bundled together in this manner comprises the photosensitive printing plates and the slip sheets alternately stacked together.

The bundle of the predetermined plural number of photosensitive printing plates integrally bundled together in this manner is packaged in packaging paper (packaging material) that blocks out light and prevents moisture. For the packaging paper (packaging material), paper whose ability to block out light and prevent moisture is high is used. Examples thereof include aluminum graft paper, which is formed by dissolving and applying polyethylene to graft paper and then adhering aluminum foil threto, and black polyethylene graft paper, which is formed by applying melted polyethylene mixed with black carbon onto graft paper.

In order to prevent the photosensitive printing plates and the packaging paper from sustaining damage during the processes of transporting and storing the photosensitive printing plates, a packaging box is separately manufactured, and the photosensitive printing plates packaged in the packaging paper are disposed in the packaging box. For example, corrugated cardboard, which is lightweight and strong, is used for the packaging box.

In conventional photosensitive printing plate packaging, in order to ensure that the photosensitive printing plates can be easily unpackaged in a bright room when the bundle of the packaged photosensitive printing plates is loaded into the photosensitive printing plate feeding apparatus of the automatic platemaker, there has been proposed means which enables: and the photosensitive printing plates to be packaged in packaging material that can be divided into two; the bundle of the photosensitive printing plates packaged in the packaging material that can be divided into two to be set inside the photosensitive printing plate feeding apparatus of the automatic platemaker such that the bundle is shielded from light with the lid closed. The means also enables, thereafter, part of the packaging material to be removed while the light-shielded state is maintained inside the photosensitive printing plate feeding apparatus by pulling out part of the packaging material that can be divided into two protruding from a gap in the closed lid (e.g., see Japanese Patent Application Publication (JP-A) No. 11-314680).

Moreover, in photosensitive printing plate feeding apparatus of conventional platemakers, it is possible to: open the packaging of the photosensitive printing plates in a darkroom and remove the sheets of thick paper (contact board) from the back sides of the photosensitive printing plates; thereafter, put the bundle of the plural photosensitive printing plates and slip sheets in the printing plate packaging box, close the open/close lid, and shield the photosensitive printing plates from light; carry this to the photosensitive printing plate feeding apparatus of the automatic platemaker disposed in the darkroom and load it into a printing plate feeding cassette inside the photosensitive printing plate feeding apparatus; close the doors of the photosensitive printing plate feeding apparatus, open the open/close lid of the printing plate packaging box with an automatic device, separate the photosensitive printing plates one plate at a time with a sheet feeding apparatus of the automatic feeding apparatus from the bundle of the photosensitive printing plates inside the printing plate packaging box, and convey the photosensitive printing plates to the exposure unit. In order to enable this action, means have been proposed which allow the light-shielding property to be maintained by storing the photosensitive printing plates in the printing plate packaging box and carrying the box through the bright room (e.g., see JP-A No. 11-314771).

However, in the means which removes part of the packaging material while maintaining the light-shielded state inside the conventional photosensitive printing plate feeding apparatus described above, the automatic device for removing the slip sheets, whose structure is complicated and large, becomes separately necessary in order to remove, and to stock in a disposal place, the slip sheets from the photosensitive surface front sides of the photosensitive printing plates from which the packaging material has been removed while maintaining the light-shielded state inside the photosensitive printing plate feeding apparatus. In other words, there is the problem that the CTP system disposed with the photosensitive printing plate feeding apparatus becomes large and expensive.

Also, in the means which enables the light-shielding property to be maintained by storing the photosensitive printing plates in the printing plate packaging box and carrying the box through a bring darkroom, a worker must open the packaging resulting from the packaging paper, remove the bundle comprising the photosensitive printing plates and the slip sheets alternately stacked together, remove the sheets of thick paper from the front and back sides of the bundle, store them in the printing plate packaging box, and close the open/close lid when the bundle of the photosensitive printing plates are to be supplied to the photosensitive printing plate feeding apparatus.

Next, the worker must load, into the printing plate feeding cassette inside the photosensitive printing plate feeding apparatus, the printing plate packaging box in which is stored the bundle comprising the photosensitive printing plates and the slip sheets alternately stacked together, and close the doors of the photosensitive printing plate feeding apparatus to shield the inside of the apparatus from light.

Then, in the photosensitive printing plate feeding apparatus, the open/close lid of the printing plate packaging box is opened by the automatic device, just the photosensitive printing plates are separated one plate at a time by a sheet takeout mechanism of the automatic feeding apparatus from the bundle that is stored inside the printing plate packaging box and comprises the photosensitive printing plates and the slip sheets alternately stacked together, the photosensitive printing plates are conveyed to the exposure unit, the slip sheets are separated from the photosensitive surfaces of the photosensitive printing plates by a slip sheet removal mechanism, and the separated slip sheets are conveyed by a slip sheet conveyance mechanism to a slip sheet collection unit and stocked in the slip sheet disposal place of the slip sheet collection unit.

When the means which enables the light-shielding property to be maintained by storing the photosensitive printing plates in the printing plate packaging box and carrying the box through a bright room is used, it is necessary to separately dispose, in the conventional photosensitive printing plate feeding apparatus, the slip sheet removal mechanism, the slip sheet conveyance mechanism, and the slip sheet collection unit for removing the slip sheets from the photosensitive surfaces of the photosensitive printing plates and stocking the slip sheets in the disposal space, and the structures of these are complicated, large, and take up a wide space. In other words, there is the problem that the structure of the CTP system disposed with the photosensitive printing plate feeding apparatus becomes complicated, large, and expensive.

Also, in a CTP system disposed with such a photosensitive printing plate feeding apparatus, the slip sheet removal mechanism, the slip sheet conveyance mechanism, and the slip sheet collection unit operate continuously. Thus, the operation of the sheet feeding apparatus for removing the next photosensitive printing plate cannot be started until the work of removing the slip sheets is finished. Consequently, it takes a long time to take out and feed the photosensitive printing plates to the exposure unit, which lowers the productivity of the image forming apparatus.

### SUMMARY OF THE INVENTION

In view of these problems, it is an object of the present invention to provide a novel photosensitive printing plate automatic feeding apparatus and method with which productivity can be improved and the configuration of the apparatus can be simplified and compacted, and which can be manufactured inexpensively, by ensuring that a bundle of just photosensitive printing plates is loaded into the apparatus and that just the photosensitive printing plates are separated and quickly conveyed one plate at a time using a sheet feeding apparatus.

In a first aspect of the invention, the photosensitive printing plate automatic feeding apparatus is configured to include a sheet feeding apparatus that separates and conveys, to an exposure apparatus, photosensitive printing plates one plate at a time from a bundle of the photosensitive printing plates, wherein the sheet feeding apparatus is configured such that the one-plate-at-a-time conveyance of the photosensitive printing plates to the exposure apparatus is possible in a state where a bundle comprising a predetermined plural number of photosensitive printing plates stacked together has been loaded into the automatic feeding apparatus, the photosensitive printing plates having the characteristic that transport and storage are possible in a state where the photosensitive printing plates have been stacked together with back sides of the photosensitive printing plates being in direct contact with photosensitive surfaces on front sides of the photosensitive printing plates.

By configuring the automatic feeding apparatus in this manner, a bundle comprising a predetermined plural number of the photosensitive printing plates stacked together without slip sheets can be loaded into the automatic feeding apparatus, and the photosensitive printing plates can be separated one sheet at a time and conveyed by the sheet feeding apparatus to the exposure apparatus. Consequently, it is not necessary to dispose, in the automatic feeding apparatus, a (conventional) configuration for separating the slip sheets from the photosensitive surfaces of the photosensitive printing plates with a slip sheet removing mechanism and conveying the separated slip sheets with a slip sheet conveyance mechanism to a slip sheet collection unit and stocking the slip sheets in a slip sheet disposal place in the slip sheet collection unit.

Also, the process of separating, conveying, and stocking the slip sheets can be omitted, so that the photosensitive printing plates can be sequentially taken out.

In a second aspect of the invention, the photosensitive printing plate automatic feeding apparatus is configured to include: a storage shelf on which is placed a bundle comprising a predetermined plural number of photosensitive printing plates stacked together, the storage shelf including a shelf member on which is placed an end portion of the bundle of photosensitive printing plates and a support base disposed diagonally such that the photosensitive printing plates diagonally rest on the storage shelf, with the photosensitive printing plates having the characteristic that transport and storage are possible in a state where the photosensitive printing plates have been stacked together with back sides of the photosensitive printing plates being in direct contact with photosensitive surfaces on front sides of the photosensitive printing plates; takeout means that separates and takes out the photosensitive printing plates one plate at a time from the bundle of photosensitive printing plates placed on the storage shelf; a primary conveyor belt winding mechanism including a primary conveyor belt disposed along a conveyance path on which the photosensitive printing plate taken out by the takeout means is conveyed to an exposure apparatus; a secondary conveyor belt winding mechanism including a secondary conveyor belt that presses and retains the photosensitive printing plate against the primary conveyor belt; an intermediate roller disposed such that the primary conveyor belt and the secondary conveyor belt meet at a conveyance-direction upstream side; and a leading end roller disposed to set a guide range in which the leading end of the photosensitive printing plate taken out by the takeout means strikes the primary conveyor belt extending from the intermediate roller

In a third aspect of the invention, the takeout means of the photosensitive printing plate automatic feeding apparatus based on the second aspect is configured by a takeout-use roller.

In a fourth aspect of the invention, the takeout means of the photosensitive printing plate automatic feeding apparatus based on the second aspect is configured to suck, lift up, and retain the photosensitive printing plates with a sucker disposed on a leading end of a takeout-use operation arm and move the photosensitive printing plates in a conveyance direction.

By configuring the automatic feeding apparatus in this manner, a bundle comprising a predetermined plural number of the photosensitive printing plates stacked together without slip sheets can be loaded into the automatic feeding apparatus, and the photosensitive printing plates can be separated one sheet at a time and conveyed by the sheet feeding apparatus to the exposure apparatus. Thus, it is not necessary to dispose, in the automatic feeding apparatus, a (conventionally necessary) configuration for separating the slip sheets from the photosensitive surfaces of the photosensitive printing plates with a slip sheet removing mechanism and conveying the separated slip sheets with a slip sheet conveyance mechanism to a slip sheet collection unit and stocking the slip sheets in a slip sheet disposal place in the slip sheet collection unit.

Also, the process of separating, conveying, and stocking the slip sheets can be omitted, so that the photosensitive printing plates can be sequentially taken out.

Also, the automatic feeding apparatus can be compacted by disposing the bundle of the photosensitive printing plates diagonally on the storage shelf such that the photosensitive printing plates fit into a narrow space inside the automatic feeding apparatus.

Also, because the leading ends of the photosensitive printing plates taken out by the takeout means are elastically received and guided by the primary conveyor belt in the guide range, the photosensitive surfaces of the photosensitive printing plates can be prevented from sustaining damage.

In a fifth aspect of the invention, the photosensitive printing plate automatic feeding apparatus is configured to include: a light-shielding cassette to which an open/close lid portion is attached such that the open/close lid portion can be opened and closed, the light-shielding cassette accommodating a bundle comprising a predetermined plural number of photosensitive printing plates stacked together, the photosensitive printing plates having the characteristic that transport and storage are possible in a state where the photosensitive printing plates have been stacked together with back sides of the photosensitive printing plates being in direct contact with photosensitive surfaces on front sides of the photosensitive printing plates; a pedestal member disposed inside the light-shielding cassette such that the bundle of the photosensitive printing plates is placed on the pedestal member; a conveyance height adjusting mechanism that causes an operation portion to extend through an operation-use opening disposed in the light-shielding cassette and push up the pedestal member in a state where the light-shielding cassette has been connected to the automatic feeding apparatus with the open/close lid portion opened; a takeout-use roller that rollingly contacts and takes out the uppermost photosensitive printing plate placed on the pedestal member; a primary conveyor belt winding mechanism including a primary conveyor belt diposed along a conveyance path on which the photosensitive printing plate taken out by the takeout-use roller is conveyed to an exposure apparatus; a secondary conveyor belt winding mechanism including a secondary conveyor belt that presses and retains the photosensitive printing plate against the primary conveyor belt; an intermediate roller disposed such that the primary conveyor belt and the secondary conveyor belt meet at a conveyance-direction upstream side; and a leading end roller disposed to set a guide range in which the leading end of the photosensitive printing plate taken out by the takeout-use roller strikes the primary conveyor belt extending from the intermediate roller.

By configuring the automatic feeding apparatus in this manner, a bundle comprising a predetermined plural number of the photosensitive printing plates stacked together without slip sheets can be loaded into the automatic feeding apparatus, and the photosensitive printing plates can be separated one sheet at a time and conveyed by the sheet feeding apparatus to the exposure apparatus. Thus, it is not necessary to dispose, in the automatic feeding apparatus, a (conventionally necessary) configuration for separating the slip sheets from the photosensitive surfaces of the photosensitive printing plates with a slip sheet removing mechanism and conveying the separated slip sheets with a slip sheet conveyance mechanism to a slip sheet collection unit and stocking the slip sheets in a slip sheet disposal place in the slip sheet collection unit.

Moreover, the process of separating, conveying, and stocking the slip sheets can be omitted, so that the photosensitive printing plates can be sequentially taken out.

Also, because the leading ends of the photosensitive printing plates taken out by the takeout-use roller are elastically received and guided by the primary conveyor belt in the guide range, the photosensitive surfaces of the photosensitive printing plates can be prevented from sustaining damage.

In the photosensitive printing plate automatic feeding apparatus of the present invention, slip sheets are eliminated so that a bundle of just the photosensitive printing plates is loaded into the automatic feeding apparatus. Consequently, the invention has the effects of: improving productivity by separately and quickly conveying the photosensitive printing plates one plate at a time with the sheet feeding apparatus; simplifying and compacting the configuration of the apparatus by eliminating structures that remove slip sheets from the photosensitive surfaces of the photosensitive printing plates and stock the slip sheets in a disposal place (i.e., a slip sheet removal mechanism, a slip sheet conveyance mechanism, and a slip sheet collection unit, which are complicated, large, and occupy a wide space); and reducing the manufacturing cost as a result of this simplification and compaction.

### BRIEF DESCRIPTION OF THE DRAWINGS

FIG. 1 is a perspective view showing a computer-to-plate (CTP) system including a photosensitive printing plate automatic feeding apparatus pertaining to an embodiment of the invention;

FIG. 2 is a schematic configural diagram showing the overall inside of the CTP system including the photosensitive printing plate automatic feeding apparatus pertaining to the embodiment of the invention;

FIG. 3 is a schematic configural diagram showing a sheet feeding apparatus that is part of the photosensitive printing plate automatic feeding apparatus pertaining to the embodiment of the invention and which takes out photosensitive printing plates from a bundle of photosensitive printing plates loaded into the apparatus;

FIG. 4 is a schematic configural diagram showing another sheet feeding apparatus that is part of the photosensitive printing plate automatic feeding apparatus pertaining to the embodiment of the invention and which takes out photosensitive printing plates from a bundle of photosensitive printing plates loaded into the apparatus; and

FIG. 5 is a schematic configural diagram showing yet another sheet feeding apparatus that is part of the photosensitive printing plate automatic feeding apparatus pertaining to the embodiment of the invention and which takes out photosensitive printing plates from a bundle of photosensitive printing plates loaded into the apparatus.

### DETAILED DESCRIPTION OF THE INVENTION

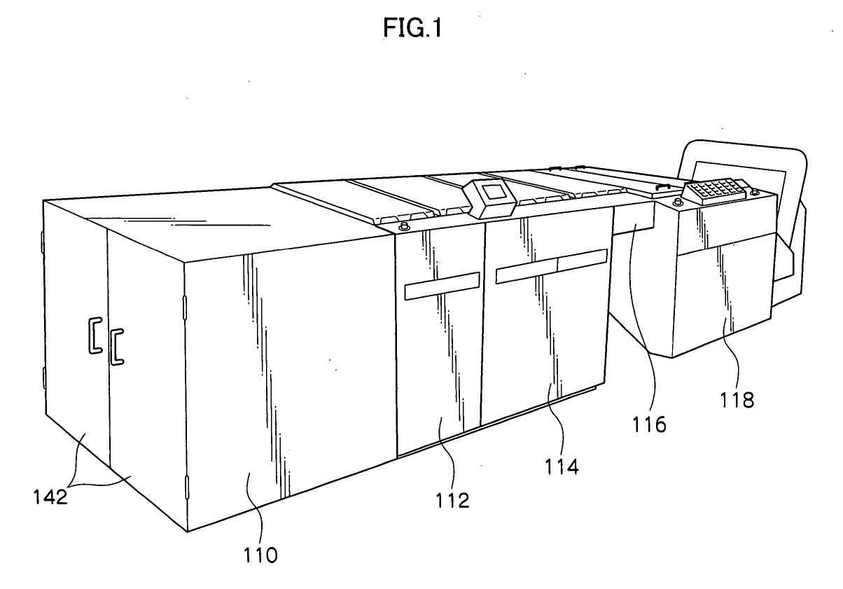

An embodiment relating to a photosensitive printing plate automatic feeding apparatus of the invention will be described with reference to FIGS. 1 to 5.

The photosensitive printing plate automatic feeding apparatus pertaining to the present embodiment is configured such that a bundle comprising a predetermined plural number of slip sheet-less photosensitive printing plates (a slip sheet-less photosensitive (PS) plate is a photopolymer PS plate whose photosensitive surface, which is formed by applying a photosensitizing agent onto the front side of the photosensitive printing plate, is at least 20 times stronger with respect to external force than common photosensitive plates currently on the market and which does not require the protection of slip sheets) stacked together is loaded into the apparatus and the photosensitive printing plates are taken out one plate at a time by a sheet feeding apparatus.

That is, the slip sheet-less photosensitive printing plates used in the photosensitive printing plate automatic feeding apparatus comprise a support, which is a thin aluminum plate formed in a rectangular plate shape having a predetermined size, and a photosensitive surface (a photosensitizing agent surface that is an image recording layer), which is formed by applying a photosensitizing agent including a photosensitive material on the support.

The slip sheet-less photosensitive printing plates used in the photosensitive printing plate automatic feeding apparatus have the characteristic that they can be transported and stored by stacking them together in a bundle in a state where the aluminum surfaces corresponding to the back sides of the photosensitive printing plates are brought into direct contact with the photosensitive surfaces (Em surfaces, which are the photosensitizing agent surfaces) corresponding to the front sides of the photosensitive printing plates without slip sheets, and that scratches and pressure marks do not arise even if the photosensitive printing plates are separated and taken out one plate at a time while the aluminum surfaces, which are the parent material of the photosensitive printing plates, slide against the photosensitive surfaces.

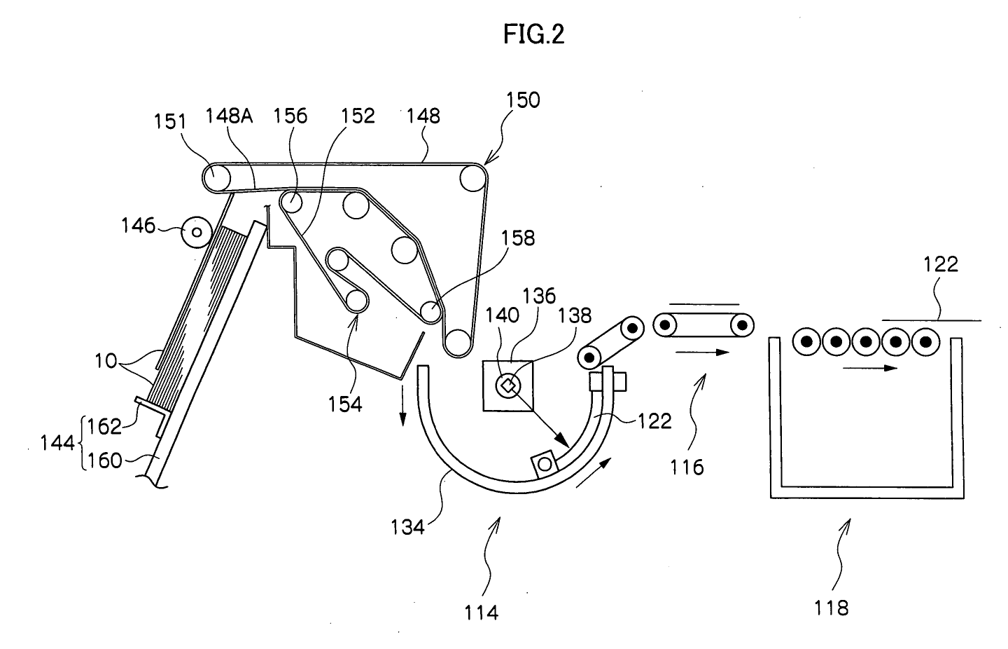

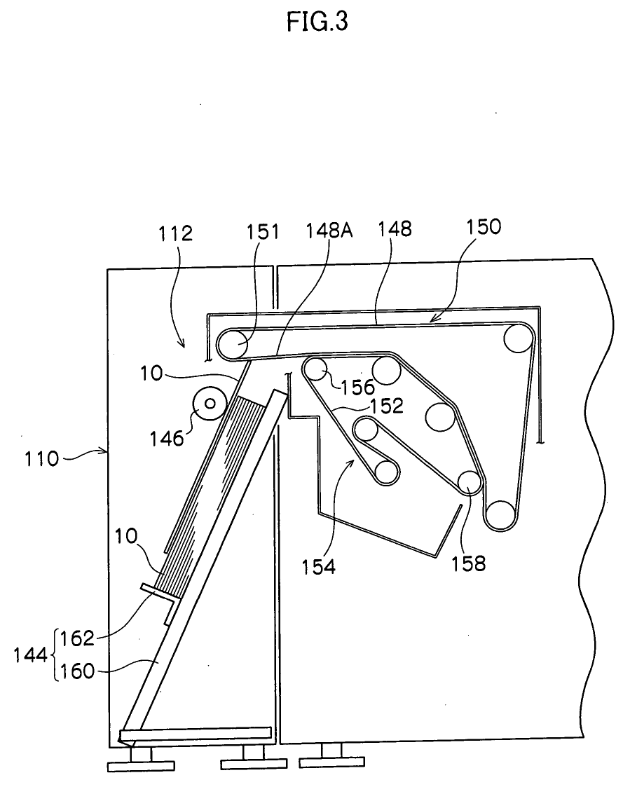

As shown in FIGS. 2 and 3, slip sheet-less photosensitive printing plates 10 are suitable for being fed, in a state where they are shielded from light, to the inside of a computer-to-plate (CTP) system that effects direct printing plate plates from a rectangular parallelepiped bundle comprising a predetermined plural number of photosensitive printing plates stacked together without slip sheets by conducting laser exposure on the basis of digital data from a computer or the like and development that converts latent images formed on the photosensitive printing plates 10 into overt images.

As shown in FIGS. 1 and 2, the CTP system includes: an automatic feeding apparatus 110 to which is fed a bundle comprising a predetermined plural number of the photosensitive printing plates 10 stacked together without slip sheets; a sheet feeding apparatus 112 that is continuous with the automatic feeder 110 and separates and feeds the photosensitive printing plates 10 (PS plates) one plate at a time from the bundle of the photosensitive printing plates 10; an inner drum exposure apparatus (monogon scanner) 114; a buffer apparatus 116; and a development apparatus 118.

The automatic feeding apparatus 110 in the CTP system is configured such that it is internally continuous with the sheet feeding apparatus 112. A storage shelf 144 is disposed inside the automatic feeding apparatus 110 in order to configure the sheet feeding apparatus 112. The storage shelf 144 is configured by attaching a shelf member 162, such that its height position is adjustable, on a support base 160 disposed diagonally from the floor of the automatic feeding apparatus 110 toward the upper portion at the inner drum exposure apparatus 114 side. When the storage shelf 144 is configured in this manner, the size of the automatic feeding apparatus 110 in the horizontal direction can be reduced and the apparatus can be compacted in comparison to when the storage shelf 144 is disposed horizontally.

As shown in FIGS. 2 and 3, when a bundle comprising a predetermined plural number of the photosensitive printing plates 10 stacked together without slip sheets is to be placed on the storage shelf 144 configured in this manner, the end portion of the bundle that is downstream in the conveyance direction is placed on the shelf member 162 so that the bundle rests diagonally on the surface of the support base 160.

A takeout-use roller (pickup roller) 146 serving as takeout means, which is moved by an unillustrated operating device between a pickup position and a withdrawn position, is disposed in the sheet feeding apparatus 112 at a position at the upper side of the storage shelf 144. In the sheet feeding apparatus 112, the takeout-use roller 146 moved to the pickup position rollingly contacts the uppermost photosensitive printing plate 10 of the bundle of the photosensitive printing plates 10 placed on the storage shelf 144, and separates and feeds the uppermost photosensitive printing plate 10 to a conveyor belt winding mechanism.

In order to convey the photosensitive printing plates 10 from the storage shelf 144 to the inner drum exposure apparatus 114, the conveyor belt winding mechanism comprises a primary conveyor belt winding mechanism 150, which includes a primary conveyor belt 148, and a secondary conveyor belt winding mechanism 154, which includes a secondary conveyor belt 152.

The primary conveyor belt winding mechanism 150 configures a conveyance path by stretching the conveyor belt 148 between an incoming position of the photosensitive printing plates 10 corresponding to the upper portion of the storage shelf 144 and an outgoing position of the photosensitive printing plates 10 leading to the inner drum exposure apparatus 114.

The secondary conveyor belt winding mechanism 154 shares the part of the conveyance path set at the lower side of the primary conveyor belt 148 of the primary conveyor belt winding mechanism 150 and is configured to prevent the conveyed photosensitive printing plates 10 from falling.

For this reason, the secondary conveyor belt winding mechanism 150 is configured such that the primary conveyor belt 148 and the secondary conveyor belt 152 meet and travel in the section from an intermediate roller 156, which is further downstream in the conveyance direction than a guide range 148A of the primary conveyor belt 148 against which the leading end of the photosensitive printing plate 10 taken out from the storage shelf 144 strikes, to an intermediate roller 158, which is near an outlet of the conveyance path set at the lower side of the primary conveyor belt 148.

When the bundle comprising a predetermined plural number of the photosensitive printing plates 10 stacked together without slip sheets is to be loaded in the automatic feeding apparatus 110 including the sheet feeding apparatus 112 configured as described above, a worker removes and prepares, in a darkroom, the bundle of the photosensitive printing plates 10 packaged in packaging material.

Next, the worker opens doors 142 of the automatic feeding apparatus 110 in the darkroom, places the bundle of the photosensitive printing plates 10 on the storage shelf 144 diagonally disposed inside the automatic feeding apparatus 110, and closes the doors 142 to block out light and turn the inside of the automatic feeding apparatus 110 into a darkroom.

Next, in the sheet feeding apparatus 112 inside the automatic feeding apparatus 110 on whose storage shelf 144 has been loaded the bundle comprising a predetermined plural number of the photosensitive printing plates 10 stacked together without slip sheets, as shown in FIGS. 2 and 3, the takeout-use roller 146 is brought into rolling contact with the uppermost photosensitive surface 10A and takes out the photosensitive printing plate 10, such that the photosensitive printing plates 10 are sequentially taken out.

As shown in FIGS. 2 and 3, in the sheet feeding apparatus 112, the takeout-use roller 146 moved from the withdrawn position to the pickup position rollingly contacts the uppermost photosensitive printing plate 10 of the bundle of the photosensitive printing plates 10, separates the photosensitive printing plates 10 one plate at a time, and feeds the photosensitive printing plate 10 to the primary conveyor belt winding mechanism 150.

In the primary conveyor belt winding mechanism 150, the leading end of the photosensitive printing plate 10 separated one plate at a time and taken out by the takeout-use roller 146 strikes the guide range 148A corresponding to the portion of the primary conveyor belt 148 stretched between a first roller 151 and the intermediate roller 156, and the leading end of the photosensitive printing plate 10 is conveyed to the intermediate roller 156 in accordance with the traveling of the primary conveyor belt 148.

In the sheet feeding apparatus 112, the leading end of the photosensitive printing plate 10 taken out by the takeout-use roller 146 strikes the primary conveyor belt 148 stretched in the guide range 148A. The primary conveyor belt 148 is easily flexibly deformed such that it receives the photosensitive printing plate 10 without imparting a shock to the photosensitive printing plate 10, and the portion of the primary conveyor belt 148 against which the leading end of the photosensitive printing plate 10 strikes becomes deformed in a general “V” shape. Thus, the photosensitive printing plate 10 bends such that its leading end portion is smoothly nipped between the primary conveyor belt 148 and the secondary conveyor belt 152 at the position of the intermediate roller 156.

In this manner, when the leading end of the photosensitive printing plate 10 strikes the primary conveyor belt 148, the photosensitive printing plate 10 is flexibly and softly received. Thus, the photosensitive layer forming the photosensitive surface 10A does not sustain external injury.

Also, in the sheet feeding apparatus 112, even when, for example, the second or third photosensitive printing plate 10 is to be taken out from the bundle of the photosensitive printing plates 10, the takeout-use roller 146 rollingly contacts the photosensitive printing plate 10, so that the leading end of the photosensitive printing plate 10 pulled up can always be appropriately taken out such that it strikes the primary conveyor belt 148 within the guide range 148A.

Thus, the sheet feeding apparatus 112 can appropriately take out the photosensitive printing plates 10 even if the pullout position changes each time one of the photosensitive printing plate 10 is pulled out from the bundle of the photosensitive printing plates 10. Thus, it is not necessary to dispose a complicated device for adjusting the pullout position of the photosensitive printing plates 10 in the storage shelf 144. In other words, the configuration of the sheet feeding apparatus 112 can be simplified, and the sheet feeding apparatus 112 can be compacted.

Additionally, the photosensitive printing plate 10 whose leading end has been guided to the primary conveyor belt 148 is nipped between the primary conveyor belt 148 and the secondary conveyor belt 152 at the position of the intermediate roller 156, conveyed on the conveyance path in the nipped state, released from the nipped state at the position of the intermediate roller 158 near the outlet, and conveyed into the inner drum exposure apparatus 114.

The inner drum exposure apparatus 114 in the CTP system is configured using, as a parent material, a support 134 whose inner peripheral surface is formed in a circular arc (shape configuring part of the inner peripheral surface of a circular cylinder). The photosensitive printing plate 10 is supported along the inner peripheral surface of the support 134.

In the inner drum exposure apparatus 114, the photosensitive printing plate 10, which is an unrecorded recording medium, is reliably adhered to the inner peripheral surface of the support 134 by unillustrated vacuum suction means such that the photosensitive printing plate 10 is retained along the inner peripheral surface of the support 134. Then, exposure is conducted.

In the inner drum exposure apparatus 114, a spinner mirror device 136 serving as a light beam deflector is disposed at a position in the center of the circular arc of the support 134. The spinner mirror device 136 includes a rotating shaft 140, to whose top surface is attached a reflective mirror member (spinner mirror) 138, that can be rotated at a high speed by a motor serving as a drive source whose rotation is controlled by a spinner driver of an unillustrated controller. In the spinner mirror device 136, the center of the axis of rotation of the rotating shaft 140 coincides with the center axis of the circular arc of the support 134.

In the spinner mirror device 136, a light beam projected from an optical system of a light source is reflected on a reflective mirror surface of the rotating reflective mirror member 138, and the photosensitive surface of the photosensitive printing plate 10 is scanned with and exposed to the light beam in a main scanning direction.

The spinner mirror device 136 sub-scans the photosensitive printing plate 10 as the result of the movement of the spinner mirror device 136 being controlled at a uniform velocity by unillustrated sub-scanning moving means in the axial line direction (direction passing from the front side of FIG. 2 to the back side) of the center axis of the circular arc of the support 134.

For this reason, in the spinner mirror device 136, the rotation of the motor is controlled by the spinner driver of the controller, and the movement of the spinner mirror device 136 is controlled in the sub-scanning direction by the unillustrated sub-scanning moving means.

The spinner mirror device 136 configured in this manner causes the laser beam projected from the optical system of the light source and modulated in accordance with image information to be reflected on the reflective mirror surface of the rotating reflective mirror member 138 to conduct scanning/exposure in the main scanning direction. While the spinner mirror device 136 conducts scanning/exposure, it is moved in the sub-scanning direction, whereby processing that records a two-dimensional image on the entire recording surface of the photosensitive printing plate 10 is conducted.

The buffer apparatus 116 disposed in the CTP system includes the function of conveying the photosensitive printing plate 10 exposed by the inner drum exposure apparatus 114 into the development apparatus 118 at a required timing by adjusting the conveyance speed.

The development apparatus 118 manufactures a printing plate by developing the exposed photosensitive printing plate 10 conveyed thereto to make the latent image overt.

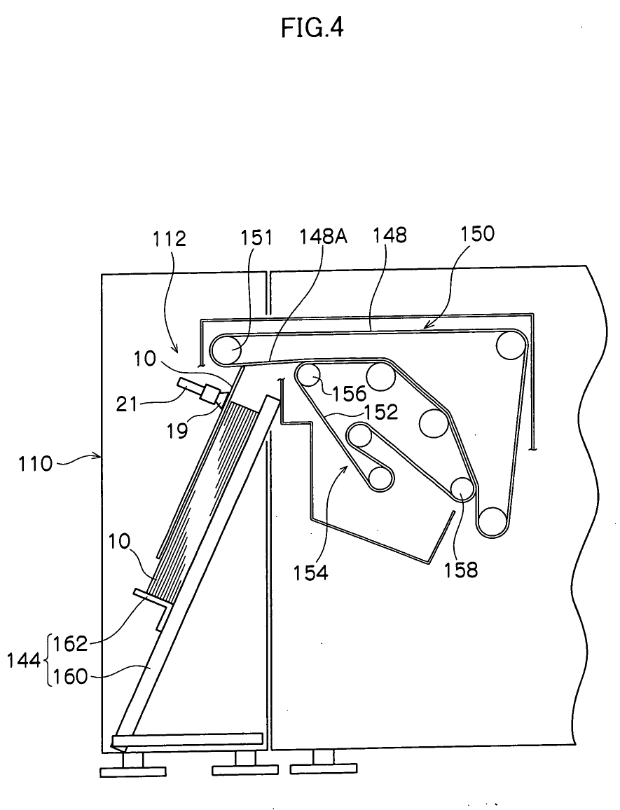

Also, the CTP system configured as shown in FIGS. 2 and 3 uses the takeout-use roller 146 as takeout means for separating and feeding just the uppermost photosensitive printing plate 10 of the bundle of the photosensitive printing plates 10 to the primary conveyor belt winding mechanism 150. However, as shown in FIG. 4, the takeout means may also be configured to suck and take out the photosensitive printing plates 10 with a sucker.

The takeout means using the sucker is configured to separate and take out one photosensitive printing plate 10 at a time by sucking, with a sucker 19 disposed on the leading end of a takeout-use operation arm 21, the surface of the uppermost photosensitive printing plate 10 of the bundle of the photosensitive printing plates 10, lifting and retaining the photosensitive printing plate 10 with the sucker 19, and moving the photosensitive printing plate 10 in the conveyance direction.

It will be noted that various other configurations can be used for the takeout means.

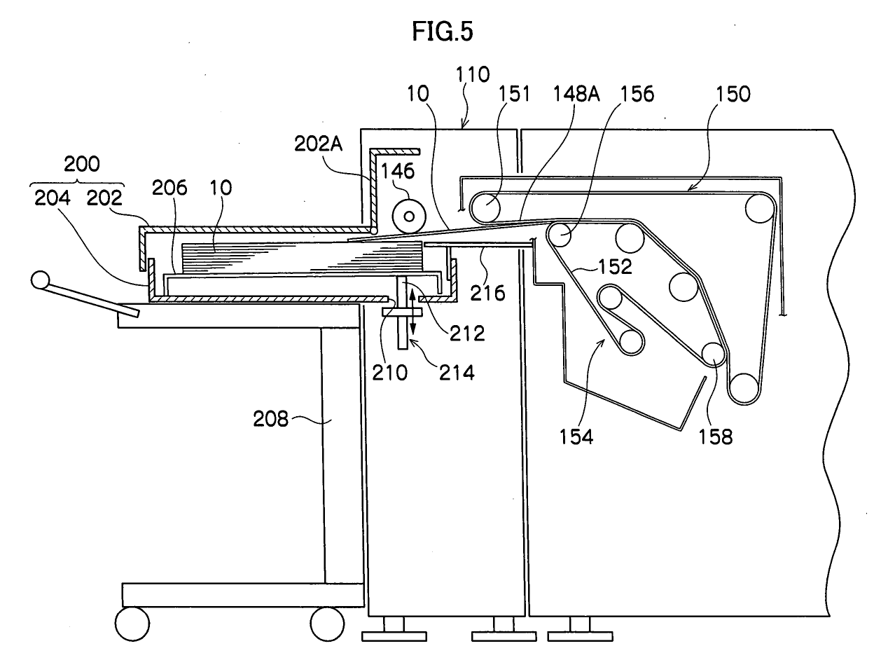

Next, another configural example pertaining to the sheet feeding apparatus 112 in the CTP system will be described with reference to FIG. 5.

In the configuration shown in FIG. 5, a bundle comprising a predetermined plural number of the photosensitive printing plates 10 stacked together without slip sheets is accommodated inside a light-shielding cassette 200 and fed to the automatic feeding apparatus 110. The light-shielding cassette 200 is configured to include a rectangular box-like lower case 204, whose upper portion is open, and an upper case 202, which is formed in a slightly larger shape than that of the lower case 204 and covers the lower case 204 such that the inside of the light-shielding cassette 200 is tightly sealed and shielded from light.

The upper case 202 includes an open/close lid portion 202A that is attached with a hinge to the end portion of the upper case 202 loaded into the automatic feeding apparatus 110. The open/close lid portion 202A is integrally configured with the upper case 202 such that the open/close lid portion 202A can be opened and closed around the hinge. A pedestal member 206 formed in a tray-like shape is disposed inside the light-shielding cassette 200, and the bundle comprising the predetermined plural number of the photosensitive printing plates 10 stacked together without slip sheets is placed on the pedestal member 206.

The light-shielding cassette 200 accommodating the bundle of the photosensitive printing plates 10 in this manner is placed on a transfer-use trolley 208 and connected to the automatic feeding apparatus 110. The open/close lid portion 202A is then opened and the light-shielding cassette 200 is set such that the photosensitive printing plates 10 inside the light-shielding cassette 200 can be picked up and conveyed.

An operation-use opening 210 for operating the pedestal member 206 is disposed in a predetermined portion of the lower case 204 facing the light-shielded interior space of the automatic feeding apparatus 110.

A conveyance height adjusting mechanism 214 including a rod-like operation member 212 that telescopically moves up and down is disposed inside the automatic feeding apparatus 110. The conveyance height adjusting mechanism 214 is configured such that the operation member 212 is extended upward and pushes the underside of the pedestal member 206 via through the operation-use opening 210, whereby the surface of the uppermost photosensitive printing plate 10 of the bundle of the photosensitive printing plates 10 placed on the pedestal member 206 is brought into contact with the takeout-use roller 146 with a predetermined pressure.

A guide member 216 is disposed inside the automatic feeding apparatus 110, at the lower side of the conveyance path of the photosensitive printing plate 10 from the leading end of the light-shielding cassette 200 to the guide range 148A of the primary conveyor belt winding mechanism 150. The guide member 216 is for preventing the photosensitive printing plate 10 from falling inside the automatic feeding apparatus 110.

In the sheet feeding apparatus 112 configured as shown in FIG. 5, the conveyance height adjusting mechanism 214 extends the operation member 212 to hold up the pedestal member 206 so that the surface of the uppermost photosensitive printing plate 10 of the bundle of the photosensitive printing plates 10 pressingly contacts the takeout-use roller 146, and the takeout-use roller 146 is rotatingly driven. The photosensitive printing plate 10 is guided such that its leading end portion strikes the guide range 148A, and is nipped and conveyed between the primary conveyor belt winding mechanism 150 and the secondary conveyor belt winding mechanism 152 at the position of the intermediate roller 156.

Moreover, when the photosensitive printing plates 10 are to be taken out from the second photosensitive printing plate 10 on, the conveyance height adjusting mechanism 214 is driven and controlled to extend the operation member 212 to hold up the pedestal member 206 so that the surface of the uppermost photosensitive printing plate 10 of the bundle of the photosensitive printing plates 10 pressingly contacts the takeout-use roller 146 with a predetermined contact pressure. Then, the photosensitive printing plate 10 is taken out by the same operation as described above.

The configuration, action, and effects of the sheet feeding apparatus 112 shown in FIG. 5 other than those described above are the same as the sheet feeding apparatus 112 shown in FIGS. 2 and 3. Thus, description thereof will be omitted.

What is claimed is:

1. A photosensitive printing plate automatic feeding apparatus comprising:
a sheet feeding apparatus that separates and conveys, to an exposure apparatus, photosensitive printing plates one plate at a time from a bundle of the photosensitive printing plates,
wherein the sheet feeding apparatus is configured such that the one-plate-at-a-time conveyance of the photosensitive printing plates to the exposure apparatus is possible in a state where a bundle comprising a predetermined plural number of photosensitive printing plates stacked together has been loaded into the automatic feeding apparatus, the photosensitive printing plates having the characteristic that transport and storage are possible in a state where the photosensitive printing plates have been stacked together with back sides of the photosensitive printing plates being in direct contact with photosensitive surfaces on front sides of the photosensitive printing plates.

2. The photosensitive printing plate automatic feeding apparatus of claim 1, further comprising:
a storage shelf on which is placed the bundle comprising the predetermined plural number of photosensitive printing plates stacked together, the storage shelf including a shelf member on which is placed an end portion of the bundle of photosensitive printing plates and a support base disposed diagonally such that the photosensitive printing plates diagonally rest on the storage shelf; and
takeout means that separates and takes out the photosensitive printing plates one plate at a time from the bundle of photosensitive printing plates placed on the storage shelf.

3. The photosensitive printing plate automatic feeding apparatus of claim 2, wherein the takeout means is configured by a takeout-use roller.

4. The photosensitive printing plate automatic feeding apparatus of claim 2, wherein the takeout means is configured to suck, lift up, and retain the photosensitive printing plates with a sucker disposed on a leading end of a takeout-use operation arm and move the photosensitive printing plates in a conveyance direction.

5. The photosensitive printing plate automatic feeding apparatus of claim 2, further comprising:
a primary conveyor belt winding mechanism including a primary conveyor belt disposed along a conveyance path on which the photosensitive printing plate taken out by the takeout means is conveyed to the exposure apparatus;
a secondary conveyor belt winding mechanism including a secondary conveyor belt that presses and retains the photosensitive printing plate against the primary conveyor belt; and
an intermediate roller disposed such that the primary conveyor belt and the secondary conveyor belt meet at a conveyance-direction upstream side.

6. The photosensitive printing plate automatic feeding apparatus of claim 5, further including a leading end roller disposed to set a guide range in which the leading end of the photosensitive printing plate taken out by the takeout means strikes the primary conveyor belt extending from the intermediate roller.

7. The photosensitive printing plate automatic feeding apparatus of claim 1, further comprising:
a light-shielding cassette to which an open/close lid portion is attached such that the open/close lid portion can be opened and closed, the light-shielding cassette accommodating the bundle comprising a predetermined plural number of photosensitive printing plates stacked together, the photosensitive printing plates having the characteristic that transport and storage are possible in a state where the photosensitive printing plates have been stacked together with back sides of the photosensitive printing plates being in direct contact with photosensitive surfaces on front sides of the photosensitive printing plates;
a pedestal member disposed inside the light-shielding cassette such that the bundle of the photosensitive printing plates is placed on the pedestal member;
a conveyance height adjusting mechanism that causes an operation portion to extend through an operation-use opening disposed in the light-shielding cassette and push up the pedestal member in a state where the light-shielding cassette has been connected to the automatic feeding apparatus with the open/close lid portion opened; and
a takeout-use roller that rollingly contacts and takes out the uppermost photosensitive printing plate placed on the pedestal member.

8. The photosensitive printing plate automatic feeding apparatus of claim 7, further comprising:
a primary conveyor belt winding mechanism including a primary conveyor belt along a conveyance path on which the photosensitive printing plate taken out by the takeout means is conveyed to the exposure apparatus;
a secondary conveyor belt winding mechanism including a secondary conveyor belt that presses and retains the photosensitive printing plate against the primary conveyor belt; and
an intermediate roller disposed such that the primary conveyor belt and the secondary conveyor belt meet at a conveyance-direction upstream side.

9. The photosensitive printing plate automatic feeding apparatus of claim 8, further comprising a leading end roller disposed to set a guide range in which the leading end of the photosensitive printing plate taken out by the takeout means strikes the primary conveyor belt extending from the intermediate roller.

10. The photosensitive printing plate automatic feeding apparatus of claim 9, further comprising a guide member disposed between the takeout-use roller and the leading end roller in order to prevent the photosensitive printing plate from falling inside the automatic feeding apparatus.

11. A photosensitive printing plate automatic feeding apparatus comprising:
a storage shelf on which is placed a bundle comprising a predetermined plural number of photosensitive printing plates stacked together, the storage shelf including a shelf member on which is placed an end portion of the bundle of photosensitive printing plates and a support base disposed diagonally such that the photosensitive printing plates diagonally rest on the storage shelf, with the photosensitive printing plates having the characteristic that transport and storage are possible in a state where the photosensitive printing plates have been stacked together such that back sides of the photosensitive printing plates being in direct contact with photosensitive surfaces on front sides of the photosensitive printing plates;
takeout means that separates and takes out the photosensitive printing plates one plate at a time from the bundle of photosensitive printing plates placed on the storage shelf;
a primary conveyor belt winding mechanism including a primary conveyor belt disposed along a conveyance path on which the photosensitive printing plate taken out by the takeout means is conveyed to an exposure apparatus;
a secondary conveyor belt winding mechanism including a secondary conveyor belt that presses and retains the photosensitive printing plate against the primary conveyor belt;
an intermediate roller disposed such that the primary conveyor belt and the secondary conveyor belt meet at a conveyance-direction upstream side; and
a leading end roller disposed to set a guide range in which the leading end of the photosensitive printing plate taken out by the takeout means strikes the primary conveyor belt extending from the intermediate roller.

12. The photosensitive printing plate automatic feeding apparatus of claim 11, wherein the takeout means is configured by a takeout-use roller.

13. The photosensitive printing plate automatic feeding apparatus of claim 11, wherein the takeout means is configured to suck, lift up, and retain the photosensitive printing plates with a sucker disposed on a leading end of a takeout-use operation arm and move the photosensitive printing plates in a conveyance direction.

14. A photosensitive printing plate automatic feeding apparatus comprising:
a light-shielding cassette to which an open/close lid portion is attached such that the open/close lid portion can be opened and closed, the light-shielding cassette accommodating a bundle comprising a predetermined plural number of photosensitive printing plates stacked together, the photosensitive printing plates having the characteristic that transport and storage are possible in a state where the photosensitive printing plates have been stacked together with back sides of the photosensitive printing plates being in direct contact with photosensitive surfaces on front sides of the photosensitive printing plates;
a pedestal member disposed inside the light-shielding cassette such that the bundle of the photosensitive printing plates is placed on the pedestal member;
a conveyance height adjusting mechanism that causes an operation portion to extend through an operation-use opening disposed in the light-shielding cassette and push up the pedestal member in a state where the light-shielding cassette has been connected to the automatic feeding apparatus with the open/close lid portion opened;
a takeout-use roller that rollingly contacts and takes out the uppermost photosensitive printing plate placed on the pedestal member;
a primary conveyor belt winding mechanism including a primary conveyor belt disposed along a conveyance path on which the photosensitive printing plate taken out by the takeout-use roller is conveyed to an exposure apparatus;
a secondary conveyor belt winding mechanism including a secondary conveyor belt that presses and retains the photosensitive printing plate against the primary conveyor belt;
an intermediate roller disposed such that the primary conveyor belt and the secondary conveyor belt meet at a conveyance-direction upstream side; and
a leading end roller disposed to set a guide range in which the leading end of the photosensitive printing plate taken out by the takeout-use roller strikes the primary conveyor belt extending from the intermediate roller.

15. The photosensitive printing plate automatic feeding apparatus of claim 14, further including a guide member disposed between the takeout-use roller and the leading end roller in order to prevent the photosensitive printing plate from falling inside the automatic feeding apparatus.

16. An apparatus that automatically feeds photosensitive printing plates having the characteristic that transport and storage are possible in a state where the photosensitive printing plates have been stacked together with back sides of the photosensitive printing plates being in direct contact with photosensitive surfaces on front sides of the photosensitive printing plates, the apparatus comprising:
a storage member that accommodates a bundle comprising a plural number of the photosensitive printing plates stacked together without slip sheets;
a takeout member that separates and takes out the photosensitive printing plates from the bundle one plate at a time; and
a conveyance member that conveys the taken-out photosensitive printing plates to an exposure apparatus,
wherein the conveyance member includes plural rollers and an endless belt wound around the rollers, the conveyance member being configured such that leading ends of the photosensitive printing plates taken out by the takeout member strike the endless belt and are conveyed to the exposure apparatus by the endless belt.

17. The photosensitive printing plate automatic feeding apparatus of claim 16, wherein the conveyance member includes two endless belts that are mutually adjacent between the takeout member and the exposure apparatus, and the conveyance member is configured such that the photosensitive printing plate taken out by the takeout member strikes one endless belt, is then nipped between the two endless belts, and is moved and conveyed to the exposure apparatus.

18. A method of automatically feeding and developing photosensitive printing plates having the characteristic that transport and storage are possible in a state where the photosensitive printing plates have been stacked together with back sides of the photosensitive printing plates being in direct contact with photosensitive surfaces on front sides of the photosensitive printing plates, the method comprising the steps of:
accommodating a bundle comprising a plural number of the photosensitive printing plates stacked together without slip sheets;
separating and taking out the photosensitive printing plates from the bundle one plate at a time; and
conveying the taken-out photosensitive printing plates to an exposure apparatus.

19. The method of claim 18, wherein the conveyance step includes the sub-step of causing the photosensitive printing plate to strike one belt, be nipped between the one belt and another belt, and be conveyed to the exposure apparatus.
